(19) United States
(12) Patent Application Publication
(10) Pub. No.: US 2026/0048648 A1
(43) Pub. Date: Feb. 19, 2026

(54) CARRIER FOR CARRYING AN ELECTRICAL ENERGY STORAGE DEVICE ON A FRAME OF A COMMERCIAL VEHICLE

(71) Applicant: DAIMLER TRUCK AG, Leinfelden-Echterdingen (DE)

(72) Inventors: André NOWROTH, Stuttgart (DE); Mario LIST, Insheim (DE); Carsten BERGELT, Berglen (DE); Christian POPPLER, Stuttgart (DE); Jan-Philipp MIELKE, Stuttgart (DE)

(21) Appl. No.: 19/102,993

(22) PCT Filed: Jul. 26, 2023
(86) PCT No.: PCT/EP2023/070701

§ 371 Date: Feb. 11, 2025

(30) Foreign Application Priority Data
Aug. 12, 2022 (DE) 10 2022 120 470.7

(51) Int. Cl. B60K 1/04

(52) U.S. Cl. CPC B60K 1/04; B60Y 2200/14; B60Y 2306/01

(57) ABSTRACT

A carrier has a receiving area in which an energy storage device is received. The carrier has a base frame, which can be placed on and fixed to a vehicle frame and delimits the receiving area towards the bottom in the vertical direction of the vehicle. The carrier also has a carrier box formed separately from and arranged on the base frame, and delimiting the receiving area in the transverse direction of the vehicle. The carrier box is supported on the base frame and fixed to the base frame via the consoles, which fold rearwards in the longitudinal direction of the vehicle in the event of an accident-related application of force acting rearwards in the longitudinal direction of the vehicle and to thereby release an accident-related movement of the carrier box rearwards in the longitudinal direction of the vehicle.

### BACKGROUND AND SUMMARY OF THE INVENTION

Exemplary embodiments of the invention relate to a carrier for carrying at least one electrical energy storage device on a frame of a commercial vehicle.

CN 211195826 U discloses a framework arrangement for a vehicle battery. Furthermore, a frame for an energy storage device is taken as known from CN 216153582 U.

Exemplary embodiments of the present invention are directed to a carrier for carrying at least one electric energy storage device on a frame of a commercial vehicle, so that a particularly advantageous accident behavior can be implemented.

The invention relates to a carrier, also referred to as a carrier device, for supporting and thus carrying at least one electrical energy storage device on a frame, shaped in particular as a ladder frame, of a commercial vehicle, in particular a truck. This means that, in its completely assembled state, the commercial vehicle includes the electrical energy storage device, the frame and the carrier. The electrical energy storage device is carried or to be carried on the frame via the carrier, particularly in such a way that the electrical energy storage device is held on the carrier and the carrier is held on the frame. Electrical energy can be stored by means of the electrical energy storage device, in particular electrochemically. In particular, the electrical energy storage device is a high-voltage component, the electric voltage of which, in particular electric operating or rated voltage, is preferably greater than 50 volts, in particular greater than 60 volts, and more preferably is several hundred volts. The commercial vehicle, designed as a motor vehicle and also simply referred to as a vehicle, can be an electric vehicle or a hybrid vehicle. In particular, the commercial vehicle can be a battery electric vehicle or a fuel cell vehicle. In its completely assembled state, the commercial vehicle, also referred to as a motor vehicle, has at least one electric engine by means of which the commercial vehicle can be electrically driven, in particular purely electrically. In this case, the electric engine can be supplied with the electrical energy stored or to be stored in the electrical energy storage device, by what the electric engine can be operated in a motor operation and thus as an electric motor. The motor vehicle can be driven electrically, in particular purely electrically, by means of the electric motor.

The carrier has a receiving area. In particular, the receiving area is delimited, in particular directly, by the carrier. The electrical energy storage device can be or is fixed on the carrier. Furthermore, the electrical energy storage device can be or is received in the receiving area. This means that in the completely assembled state of the commercial vehicle, the electrical energy storage device is received in the receiving area, wherein the electrical energy storage device is fixed on the carrier. In particular, it is conceivable that the electrical energy storage device can be or is fixed in the receiving area on the carrier. Thus, the electrical energy storage device can be or is fixed on the frame by means of the carrier and thus is to be or is carried on the frame.

In order to realize a particularly advantageous accident behavior and thus a particularly high level of safety, it is provided according to the invention that the carrier has a base frame that can be placed on the frame and is accordingly formed separately from the frame, which base frame can be fixed or is fixed to the frame of the commercial vehicle, also known as the vehicle frame. Furthermore, the base frame delimits, in particular directly, the receiving area, in the built-in position of the carrier, towards the bottom in the vehicle vertical direction of the commercial vehicle. Thereby, the carrier takes its built-in position in the completely assembled state of the commercial vehicle equipped with the carrier. This means that in the built-in position of the carrier and thus in the completely assembled state of the commercial vehicle, the carrier is fixed on the frame, wherein in particular the base frame is placed, particularly directly, on the frame, and is fixed on the frame.

The carrier also has a carrier box which is formed separately from the base frame and thus also separately from the frame (vehicle frame) and is arranged on the base frame, in particular as viewed in the vehicle vertical direction of the commercial vehicle, which carrier box delimits the receiving area, in the built-in position of the carrier, in the transverse direction of the vehicle, in particular directly, in particular on both sides. In the built-in position of the carrier in the longitudinal direction of the vehicle, the carrier box is supported at the rear on the base frame via consoles. Furthermore, the carrier box is fixed via the consoles on the base frame. The consoles are designed to fold backwards in the longitudinal direction of the vehicle in the event of an accident-related application of force towards the rear in the longitudinal direction of the vehicle, i.e., acting from front to rear, and to thereby release an accident-related movement of the carrier box towards the rear in the longitudinal direction of the vehicle, i.e., to enable an accident-related rearward displacement of the carrier box. In other words, if an accident-related force is applied to the commercial vehicle from the front to the rear in the longitudinal direction of the vehicle, and thus in particular to the carrier, for example as a result of a frontal collision of the commercial vehicle, the consoles fold rearwards in the longitudinal direction of the vehicle, in particular relative to the base frame, and thereby release the carrier box for a movement towards the rear in the longitudinal direction of the vehicle that is effected relative to the base frame and preferably also relative to the vehicle frame.

In the completely assembled state of the commercial vehicle, the latter has, for example, a superstructure connected to the carrier at the front in the longitudinal direction of the vehicle and designed in particular as a driver's cab, which superstructure is designed separately from the vehicle frame and separately from the carrier and is supported in particular on the vehicle frame. In particular, if the superstructure is the driver's cab, a person such as the driver of the commercial vehicle can be in the driver's cab (superstructure), for example, in particular during a ride of the commercial vehicle. Because the consoles fold backwards in the longitudinal direction of the vehicle when the force is applied to the rear in the longitudinal direction of the vehicle as a result of an accident, thus releasing the carrier box for accident-related rearward displacement, the consoles allow the carrier box, which is designed as a tower or forms a tower, for example, to move rearwards in the longitudinal direction of the vehicle away from the superstructure. In this way, for example, an excessive, undesired interaction between the carrier box and the superstructure can be avoided during the accident-related application of force. In particular, in this way, an excessive, accident-related deformation, in particular of the driver's cab or superstructure, can be avoided, so that a particularly high level of safety can be realized. The invention thus allows a conscious use of geometries for generating a kinematics, which involves, in particular, the consoles folding backwards, in particular folding away, during the accident-related application of force in the vehicle longitudinal direction and subsequently allowing a movement, in particular a folding, of the carrier box in vehicle longitudinal direction to the rear and especially away from the superstructure. Again, expressed in other words, due to the fact that the consoles fold backwards in the vehicle longitudinal direction, the carrier box can, for example, also fold backwards in the vehicle longitudinal direction, if the said accident-related application of force occurs in the vehicle longitudinal direction from front to rear. The consoles thus represent cost-effective and space-efficient crash structures, by which an advantageous accident behavior can be achieved.

In an advantageous embodiment of the invention, the carrier box, in the built-in position of the carrier, is supported towards the front in the vehicle longitudinal direction of the commercial vehicle on a front stop rail provided on the base frame. This prevents undesirable movements of the carrier box. In particular, this can ensure a particularly advantageous movement of the carrier box, especially from front to rear in the longitudinal direction of the vehicle, when force is applied as a result of an accident, so that a particularly high level of safety can be achieved.

A further embodiment is characterized by the fact that the carrier box is arranged between the front stop rail and the rear consoles, particularly when viewed in the longitudinal direction of the vehicle. As a result, a particularly advantageous movement, in particular rearward displacement, of the carrier box can be achieved in the event of an accident-related application of force, so that a particularly high level of safety can be achieved.

A second, independent aspect is also disclosed, which can, however, be combined with the carrier according to the invention or embodiments thereof. In the second aspect, the base carrier has a longitudinal direction of extension which, in the built-in position of the carrier, runs in the vehicle transverse direction of the commercial vehicle. In particular, this means that the base frame has a first extension running in the transverse direction of the vehicle, a second extension running in the longitudinal direction of the vehicle and a third extension running in the vertical direction of the vehicle, the first extension being greater than the second extension and greater than the third extension, so that the first extension is a longitudinal extension of the base frame, the longitudinal extension of which runs in the transverse direction of the vehicle and thus along the longitudinal extension direction. Thereby, the carrier box has, for example, side elements that are spaced apart from one another in the longitudinal extension direction of the base frame and delimit the receiving area in the transverse direction of the vehicle when the carrier is in the built-in position.

One embodiment of the second aspect is characterized by the fact that the carrier box has at least one strut that delimits the receiving area, in the built-in position of the carrier, towards the front or rear in the longitudinal direction of the vehicle, which strut is formed separately from the side elements and is connected to the side elements. In this way, a particularly high degree of rigidity of the carrier forming the aforementioned tower, for example, can be realized in a particularly weight-efficient manner.

In a further embodiment of the second aspect, it is provided that, in the built-in position of the carrier, the strut extends at an angle to the transverse direction of the vehicle and at an angle to the vertical direction of the vehicle in a plane spanned by the transverse direction of the vehicle and the vertical direction of the vehicle.

A further embodiment of the second aspect is characterized in that the respective side element has intersecting strut elements which delimit triangular through-openings of the respective side element.

A third, in particular independent, aspect relates to a modular system for several construction variants of a carrier according to the second aspect. The modular system according to the third aspect has the base frame as a base frame that can be used for several construction variants, and several carrier frames, which can be connected by choice to each other and to the base frame, can be arranged one above the other in the built-in position of the carrier in the vertical direction of the vehicle and each delimit a respective receiving area for a respective electrical energy storage device. Thereby, the preceding and following remarks relating to the carrier box of the carrier according to the invention and to the carrier box of the carrier according to the second aspect are also readily transferable to the respective carrier frame of the modular system according to the third aspect and vice versa.

In a particularly independent, fourth aspect, it is provided that the carrier box, which is formed separately from the base frame and arranged on the base frame and delimits the receiving area, in the built-in position of the carrier, in the transverse direction of the vehicle, is supported on a front stop rail provided on the base frame, in particular towards the front in the built-in position of the carrier in the longitudinal direction of the vehicle, and is therefore positioned relative to the base frame and fixed to the base frame via rear consoles, provided on the base frame, and via the stop rail. In this connection, the preceding and following remarks relating to the consoles of the carrier according to the invention can also be readily transferred to the consoles of the fourth aspect and vice versa, and the preceding and following remarks relating to the front stop rail of the carrier according to the invention can also be readily transferred to the stop rail of the fourth aspect and vice versa.

One embodiment of the fourth aspect is characterized in that the carrier box is arranged between the front stop rail and the rear consoles, in particular when viewed in the vehicle longitudinal direction of the commercial vehicle.

In a further embodiment of the fourth aspect, the carrier comprises a second carrier frame, which delimits a second receiving area for a second electrical energy storage device. The second carrier frame of the fourth aspect is formed separately from the base frame and separately from the first carrier box of the fourth aspect and is placed on the first carrier frame of the fourth aspect, in particular plugged on, in particular in the manner of two drinks crates stacked on top of each other and plugged into each other.

It has been shown to be particularly advantageous if the first carrier box and the second carrier box of the fourth aspect are of identical construction.

The second aspect and the third aspect make it possible to realize a force absorption path and a supporting of the electrical energy storage device in an outer region of the commercial vehicle, which is also simply referred to as a vehicle, and to introduce forces into the vehicle frame via the base frame, which is also referred to as the base carrier. As a result, a particularly high level of rigidity of the carrier can be implemented in principle via intelligent triangular structures, which can be realized in particular by the strut elements. As a result, the construction space requirement of the carrier can be kept particularly low, especially in the longitudinal direction of the vehicle, whereby particularly short wheelbases of the commercial vehicle can be realized. In addition, a modular design of the carrier can be realized so that variant-efficient structures, i.e., different design variants of the carrier, can be realized in a particularly cost-effective manner. This means, for example, that at least or exactly one electrical energy storage device, in particular one to three energy storage devices, can be located and therefore supported on the vehicle frame with a particularly small amount of construction space and material.

Preferably, the electrical energy storage device is a battery, in particular a high-voltage battery.

In the fourth aspect, the front stop rail is a front stop, wherein the rear consoles can be towing consoles, for example. The base frame, also known as the base carrier, with the front stop and the rear consoles enables at least virtually load-free and simple assembly and positioning, in particular with simultaneous tolerance compensation. Additional energy storage devices, for example in the form of high-voltage batteries, can be easily positioned using a plug-in principle, for example, in particular by arranging the carrier boxes on top of each other and plugging them into each other or onto each other, as described. For example, the carrier boxes, which are arranged on top of each other and plugged into each other, can be mounted in particular by externally accessible screw points, in particular in a belt conveyor sequence, whereby at least almost any number of energy storage devices can be built-in in a modular manner, in particular independently of a production sequence. The fourth aspect thus enables simple and cost-effective positioning and assembly of at least one or more energy storage devices, in particular in the vehicle vertical direction above the vehicle frame, which is designed in particular as a ladder frame.

Further advantages, features and details of the invention result from the following description of preferred exemplary embodiments and using the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 a schematic and perspective front view of a carrier for supporting a plurality of electrical energy storage devices on a frame of a commercial vehicle;

FIG. 2 a schematic and perspective rear view of the carrier;

FIG. 3 in part a schematic side view of the commercial vehicle;

FIG. 4 a schematic side view of the carrier;

FIG. 5 a schematic front view of the carrier;

FIG. 6 a schematic perspective view of a base frame of the carrier, also referred to as a base carrier;

FIG. 7 a schematic perspective view of a carrier box of the carrier, designed as a carrier frame;

FIG. 8 a schematic perspective view of carrier; and

FIG. 9 in part a schematic perspective view of two carrier boxes of the carrier, stacked on top of each other and plugged into each other in the manner of drinks crates.

In the figures, identical or functionally identical elements are provided with the same reference numerals.

### DETAILED DESCRIPTION

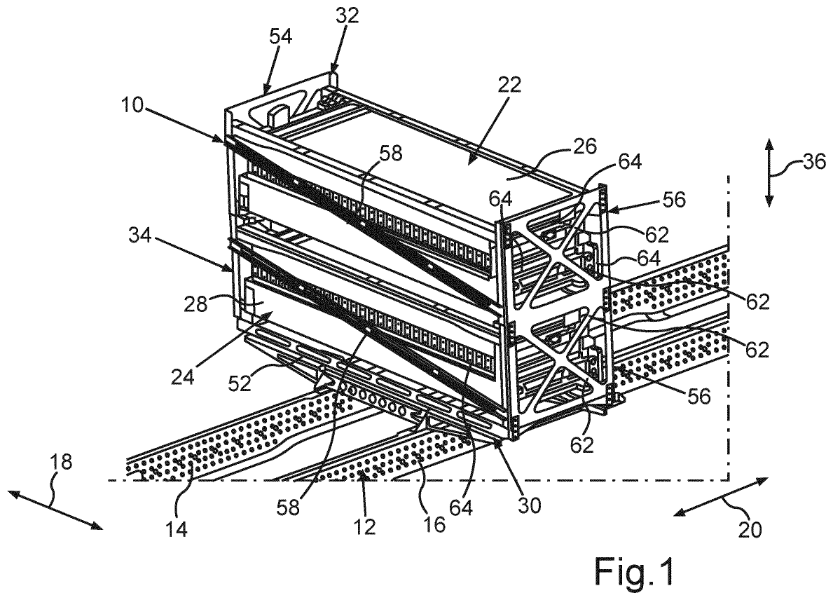

FIG. 1 shows a schematic and perspective front view of a carrier 10, also known as a carrier device or designed as a carrier device, for a commercial vehicle, also known simply as a vehicle. This means that the commercial vehicle, in its completely assembled state, has the carrier 10. The commercial vehicle also has a frame 12, a section of which can be seen in FIG. 1, which is designed as a ladder frame and is also referred to as a vehicle frame. The frame 12 (vehicle frame) has two longitudinal beams 14 and 16 spaced apart in the transverse direction of the commercial vehicle and the respective longitudinal extension direction of which runs in the longitudinal direction of the commercial vehicle. The transverse direction of the commercial vehicle is illustrated in FIG. 1 by a double-headed arrow 18, and the longitudinal direction of the commercial vehicle is illustrated in FIG. 1 by a double-headed arrow 20. The carrier 10 is attached at least indirectly, in particular directly, to the frame 12, in particular in that the carrier 10 is attached at least indirectly, in particular directly, to the longitudinal beams 14 and 16. For example, the frame 12 has at least one cross beam, not recognizable in FIG. 1, by means of which the longitudinal beams 14 and 16 are connected to one another, in particular in such a way that the cross beam is connected to the longitudinal beams 14 and 16, in particular at both ends.

The carrier 10 has receiving areas 22 and 24, which are each delimited, in particular directly, by the carrier 10. A respective electrical energy storage device 26, 28 is arranged and thus accommodated in the respective receiving area 22, 24. The respective energy storage device 26, 28 is fixed, in particular directly, to the carrier 10, so that the energy storage devices 26 and 28 are mounted and thus held on the frame 12 by means of the carrier 10, in particular using the carrier 10. The respective electrical energy storage device 26, 28 is preferably designed as a high-voltage component. In particular, the respective energy storage device 26, 28 is preferably designed as a battery, in particular as a high-voltage battery.

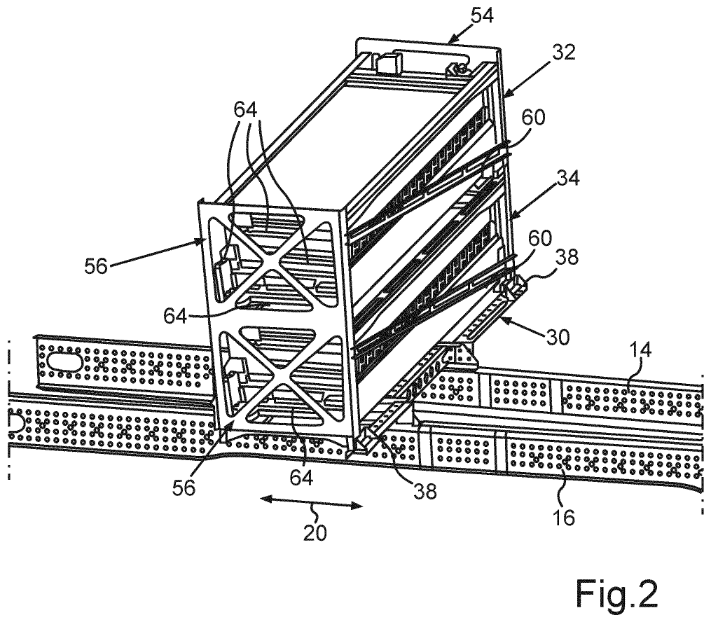

In conjunction with FIGS. 2 to 4, it can be seen that the carrier 10, which is formed separately from the frame 12, has a base frame 30, which is placed on the vehicle frame (frame 12), is fixed to the frame 12, in particular to the longitudinal members 14 and 16, and delimits the receiving area 24 towards the bottom in the vertical direction of the commercial vehicle, in particular directly, which base frame is also referred to as the base carrier. Furthermore, the carrier 10 has at least or exactly two carrier boxes 32 and 34 which are formed separately from one another and in each case separately from the base frame 30, the respective carrier box 32, 34 also being referred to as a carrier frame or formed as a carrier frame. It can be seen that the receiving area 24 in the built-in position of the carrier 10 is delimited towards the bottom, in particular directly, by the base frame 30 in the vertical direction of the commercial vehicle. The carrier 10 takes its built-in position when the commercial vehicle equipped with the carrier 10 is in its completely assembled state, wherein the built-in position of the carrier 10 is shown in the figures. The vertical direction of the commercial vehicle is illustrated by a double-headed arrow 36.

The carrier box 34, in particular in the built-in position of the carrier 10, is placed on the base frame 30 from top to bottom in the vertical direction of the vehicle, in particular directly, and is thus arranged on the base frame 30. The carrier box 34 delimits the receiving area 24 on both sides in the transverse direction of the vehicle, i.e., both to the left and to the right. In addition, the carrier box 34 delimits the receiving area 24 on both sides in the longitudinal direction of the vehicle, i.e., to the front and to the rear. It can be seen that the carrier box 32 is placed on the carrier box 34 in the vertical direction of the vehicle and is thus arranged on the carrier box 34, so that the carrier box 34 is arranged between the carrier box 32 and the base frame 30 in the vertical direction of the vehicle.

It can be seen particularly clearly from FIGS. 2, 3 and 4 that the carrier box 34 is supported towards the rear on the base frame 30 in the longitudinal direction of the vehicle (double-headed arrow 20) via consoles 38, the consoles 38 being spaced apart from one another in the transverse direction of the vehicle and thus in the longitudinal extension direction of the base frame 30 and of the respective carrier box 32, 34. In addition, the carrier box 34 is fixed to the base frame 30 via the consoles 38, in particular in such a way that the carrier box 34 is fixed, in particular directly, to the consoles 38 and/or the consoles 38 are fixed, in particular directly, to the base frame 30.

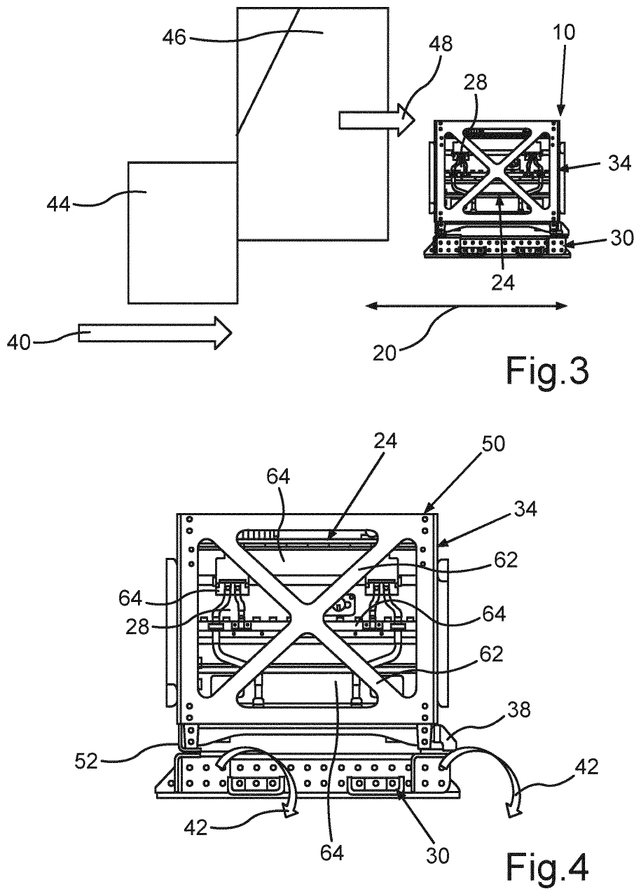

It is particularly easy to recognize from FIGS. 3 and 4 that the consoles 38 are designed to fold backwards in the longitudinal direction of the vehicle in the event of an accident-related application of force acting from the front to the rear in the longitudinal direction of the vehicle and illustrated in FIG. 3 by an arrow 40, and to thereby release, and thus enable a movement of the carrier box 34 towards the rear in the longitudinal direction of the vehicle, illustrated in FIG. 4 by arrows 42 and in particular designed as a pivoting movement.

In FIG. 3, a barrier is labelled 44. For example, in the case of a head-on collision, the commercial vehicle collides head-on with the barrier 44, resulting in the accident-related application of force illustrated by the arrow 40. It can also be seen from FIG. 3 that the commercial vehicle, for example in its fully assembled state, has a superstructure in the form of a driver's cab 46, which is formed separately from the carrier 10 and separately from the frame 12 and is supported on the frame 12. The driver's cab 46 is also referred to as a cabin. As a result of the head-on collision, i.e., as a result of the accident-related application of force resulting from the head-on collision, the cab 46, for example, is displaced rearwards in the longitudinal direction of the vehicle, in particular relative to the frame 12, this accident-related rearward displacement of the cab 46 being illustrated in FIG. 3 by an arrow 48. It can also be seen from FIG. 3 that the carrier 10 adjoins the cab 46 towards the rear in the longitudinal direction of the vehicle (double-headed arrow 20). Now, for example, in order to avoid an excessively strong collision between the driver's cab 46 and the carrier 10 and thus an excessive load on the driver's cab 46 and thus an excessive deformation of the driver's cab 46 when the force is applied as a result of an accident, the consoles 38 fold away rearwards in the longitudinal direction of the vehicle when force is applied as a result of an accident, in particular relative to the frame 12. As a result, the carrier box 34, in particular a tower 50 formed by the carrier box 34 and the carrier box 32 arranged thereon, folds away rearwards in the longitudinal direction of the vehicle when force is applied as a result of an accident and/or the carrier box 34 or the tower 50 shift rearwards in the longitudinal direction of the vehicle when force is applied as a result of an accident. In other words, a displacement of the carrier box 34 respectively the tower 50 backwards away from the driver's cab 46 in the longitudinal direction of the vehicle will be allowed, thus providing a particularly high level of safety.

It can be seen from FIGS. 1 and 4 that the carrier box 34 is preferably supported, in particular in the built-in position of the carrier 10, towards the front in the longitudinal direction of the vehicle on a front stop rail 52 provided on the base frame 30, in particular fixed thereto, wherein, for example, the carrier box 34 is arranged in the longitudinal direction of the vehicle between the front stop rail 52 and the rear consoles 38.

In the embodiment example shown in the figures, the aforementioned longitudinal direction of extension of the base frame 30 and of the respective carrier box 32, 34 extends in the transverse direction of the vehicle. For this purpose, the respective carrier box 32, 34 has side elements 54 and 56 spaced apart from one another in the longitudinal direction of extension of the respective carrier box 32, 34 and thus in the transverse direction of the vehicle and by means of which the respective receiving area 22, 24 is delimited on both sides, in particular in each case directly, in the transverse direction of the vehicle. Furthermore, the respective carrier box 32, 34 has a respective front strut 58, by means of which the respective receiving area 22, 24 is delimited towards the front in the longitudinal direction of the vehicle, in particular directly in each case. Furthermore, the respective carrier box 32, 34 has a respective rear strut 60, by means of which the respective receiving area 22, 24 is delimited towards the rear in the longitudinal direction of the vehicle, in particular directly. The respective strut 58, 60 extends at an angle to the transverse direction of the vehicle and at an angle to the vertical direction of the vehicle and in a plane spanned by the transverse direction of the vehicle and the vertical direction of the vehicle. In this way, a particularly high level of rigidity of the respective carrier box 32, 34 can be achieved in a particularly weight-optimized manner. Furthermore, the respective side element 54, 56 has intersecting strut elements 62, which in particular run in an X-shape, thus forming an X-shape. As a result, the respective strut elements 62 of the respective side element 54, 56 delimit a plurality of triangular through-openings 64 of the respective side element 54, 56 of the respective carrier box 32, 34.

In particular, the base frame 30 and the carrier boxes 32 and 34 form a modular system, by means of which different construction variants of the carrier 10 respectively the tower 50 can be assembled in a particularly simple and cost-effective manner. The base frame 30 is a cross-variant base frame used, for example, both in a first of the construction variants and in a second of the construction variants. The carrier boxes 32 and 34 are carrier frames that can be connected to each other and to the base frame 30 and can be arranged one above the other in the vertical direction of the vehicle by choice, in particular in the manner of water boxes. In the first construction variant, the base frame 30 and the carrier box 34, but not the carrier box 32, are used, for example, in order to support precisely one electrical energy storage device in the form of the electrical energy storage device 28 on the frame 12. In the second construction variant, for example, the base frame 30 and the carrier boxes 32 and 34, as shown in FIGS. 1 and 2, are used in order to thus support the, in particular exactly, two electrical energy storage devices 26 and 28 on the frame 12. In this case, the carrier box 32 is plugged onto the carrier box 34 so that the carrier boxes 32 and 34 can be stacked on top of each other like drinks crates and inserted into each other. As a result, the carrier boxes 32 and 34 can simply be placed on top of one another and thus positioned relative to one another. For example, the carrier boxes 32 and 34 are detachably connected to each other in a non-destructive manner, in particular by means of screw connections.

Preferably, the carrier box 34 is supported, in particular directly, on the front stop rail 52 provided on the base frame 30 and thus positioned relative to the base frame 30. Furthermore, the carrier box 34 is fixed to the base frame 30 via the rear consoles 38 provided on the base frame 30. Furthermore, for example, the carrier box 34 is fixed via the stop rail 52 to the base frame 30. In particular, the carrier boxes 32 and 34 are identically designed.

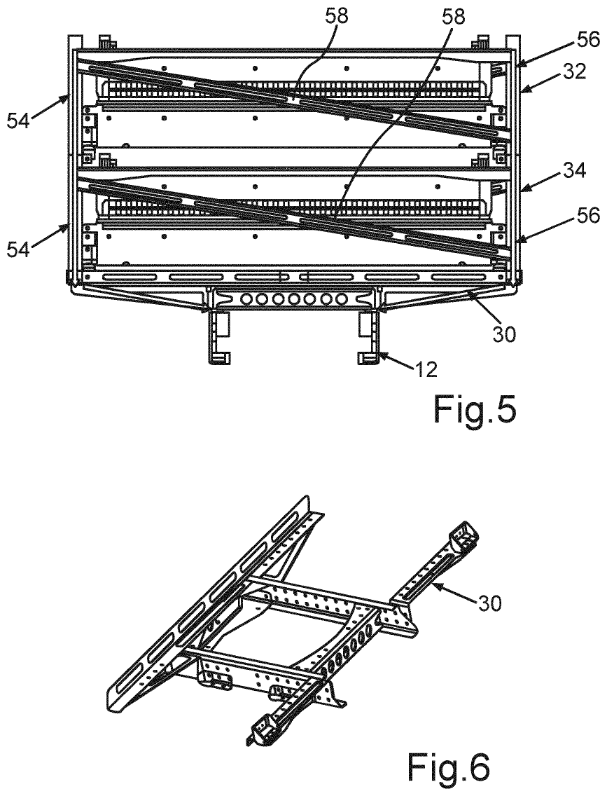

It is particularly clear from FIG. 5 that the struts 58, 60 enable the realization of particularly advantageous force paths in a particularly construction space-saving manner.

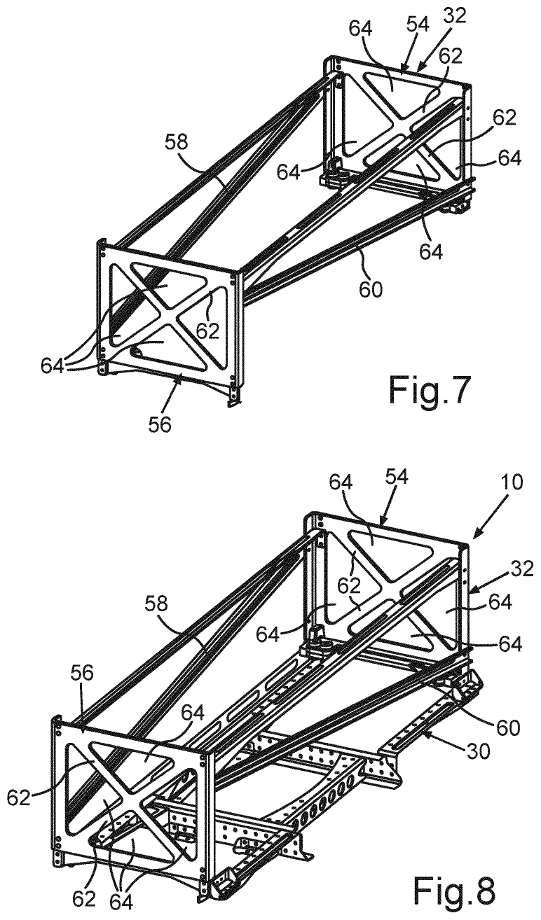

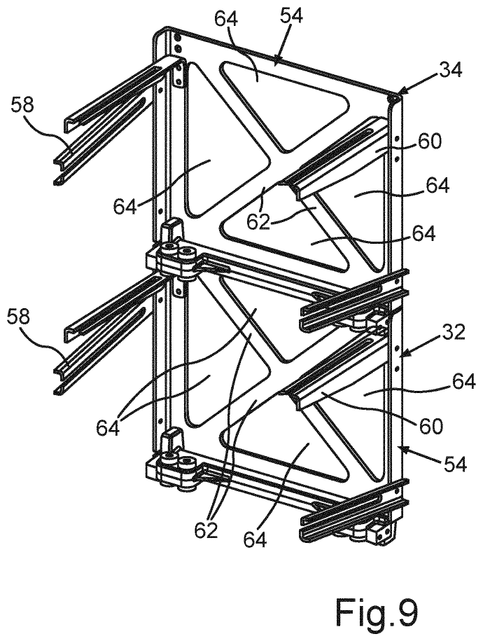

FIG. 6 shows a schematic perspective view of the base frame 30. FIG. 7 shows a schematic perspective view of the carrier box 32. FIG. 8 shows a schematic perspective view of the carrier 10 with the base frame 30 and the carrier box 32, which is now placed on the base frame 30 instead of the carrier box 34, in particular directly. Finally, FIG. 9 shows the carrier boxes 32 and 34 stacked directly on top of each other and inserted into each other in the manner of drinks crates. As can be seen from FIGS. 1 and 9, either the carrier box 32 can be placed on the carrier box 34 or the carrier box 34 can be placed on the carrier box 32 and in the process, in particular, plugged on in order to produce or assemble the carrier 10 in a modular manner.

### LIST OF REFERENCE NUMERALS

10 carrier
12 frame
14 longitudinal beam
16 longitudinal beam
18 double-headed arrow
20 double-headed arrow
22 receiving area
24 receiving area
26 electric energy storage device
28 electric energy storage device
30 base frame
32 carrier box
34 carrier box
36 double-headed arrow
38 console
40 arrow
42 arrow
44 barrier
46 driver's cab
48 arrow
50 tower
52 stop rail
54 side element
56 side element
58 strut
60 strut
62 strut element
64 through-opening

1-3. (canceled)

4. A carrier configured to support at least one electrical energy storage device on a commercial vehicle frame of a commercial vehicle, the carrier comprising:
a receiving area in which the electrical energy storage device, which is fixable to the carrier, is receivable;
a base frame configured to be placed on and fixed to the commercial vehicle frame, wherein the base frame delimits the receiving area towards a bottom in a vertical direction of the commercial vehicle in a position of the carrier installed on the commercial vehicle frame; and
at least one carrier box, formed separately from the base frame, is arranged on the base frame and delimits the receiving area in a transverse direction of the commercial vehicle in the position of the carrier installed on the commercial vehicle frame,
wherein the carrier box, in the position of the carrier installed on the commercial vehicle frame, is supported on the base frame at a rear in a longitudinal direction of the commercial vehicle via consoles and is fixed to the base frame via the consoles,
wherein the consoles are configured to fold backwards in the longitudinal direction of the commercial vehicle in event of an accident-related application of force acting rearwards in the longitudinal direction of the commercial vehicle and to release an accident-related movement of the at least one carrier box rearwards in the longitudinal direction of the commercial vehicle.

5. The carrier of claim 4, wherein the carrier box, in the position of the carrier installed on the commercial vehicle frame, is supported towards a front in the longitudinal direction of the commercial vehicle on a front stop rail provided on the base frame.

6. The carrier of claim 5, wherein the carrier box is arranged between the front stop rail and rear consoles of the consoles.
